(19) United States
(12) Patent Application Publication
(10) Pub. No.: US 2009/0174281 A1
(43) Pub. Date: Jul. 9, 2009

(54) ELECTRET POWER GENERATOR

(76) Inventors: Hsi-wen LO, Pasadena, CA (US); Yu-Chong Tai, Pasadena, CA (US)

Correspondence Address: Steinfl & Bruno, 301 N Lake Ave Ste 810, Pasadena, CA, 91101, US

(21) Appl. No.: 12/252,201

(22) Filed: Oct. 15, 2008

Related U.S. Application Data
(60) Provisional application No. 60/999,718, filed on Oct. 19, 2007.

(51) Int. Cl. H02N 11/00

(52) U.S. Cl. 310/300

(57) ABSTRACT

An electret power generator having two output electrodes on a stator and a rotor positioned above the output electrodes with charged electret material between the electrodes and the rotor. Power is generated when the rotor moves laterally above the electrodes. The electret material is preferably parylene HT .

### CROSS-REFERENCE TO RELATED APPLICATIONS

The present application is related to and claims the benefit of the following copending and commonly assigned U.S. Patent Application: U.S. Patent Application No. 60/999,718, titled “Parylene HT Based Electret Rotor Power Generator and Method of Manufacturing the Same,” filed on Oct. 19, 2007; the entire contents of which are incorporated herein by reference.

### BACKGROUND

1. Field

This disclosure relates to micro power generation. More particularly, the present describes a method and apparatus for micro power generation using a parylene-based electret.

2. Description of Related Art

Energy harvesting systems aiming to obtain power from environmental sources and produce electricity have been gaining increasing interest. One promising application of such “harvesters” may be to provide power for distributed wireless sensor nodes or “motes.” So far, most wireless sensor motes are powered by batteries and long-term continuous power supply is one of the major challenges. If continuous power can be harvested from the environment, these sensor motes can then be “set and forget”. There are many possible environmentally-based energy sources including, for example, human/animal motions, human/animal body heat, natural vibrations, and vibrations of moving vehicles.

Among the environmentally-based energy sources, linear vibrational motions are of special interest. Three methods have been developed to harvest energy from linear vibrational motion: electromagnetic; piezoelectric; and electrostatic methods. Electromagnetic power generators typically generate power when conductors, usually in the form of coils, cut across a magnetic field from a magnet. Devices utilizing the piezoelectric paradigm often involve flexible suspension beams that are made of or coated with piezoelectric materials such as lead zirconium titanate (PZT). The piezoelectric elements can deform with environmental movements and therefore produce electric power. Electrostatic micro power generators may use variable capacitors that are biased with external voltage sources (e.g., voltage-constrained) or self-biased with electret material (e.g., charge-constrained). Capacitance of the variable capacitor changes with linear motions and produces power under a voltage or charge constraint.

The micro power generators discussed above typically use some form of suspension (i.e., tethered) structures and, therefore, are generally limited to operations at their resonant frequencies. However, most environmental vibrations typically have most energy distributed below 100 Hz so the ideal resonant frequency should be low. Macro power generators can have low resonant frequencies around 20 Hz, but they are bulky. On the other hand, micro power generators are small but are usually have resonant frequencies above 100 Hz. Hence, it is desirable to develop micro power generators that do not have tethers to the rotors (i.e., with a resonant frequency near zero) and, therefore, have a wide bandwidth covering the energy-rich low frequency band.

Boland et al disclosed a micro electret power generator that did not use spring proof mass structures in “Micro Electret Power Generator, ” Proc. List. Conf. MEMS'03, 2003. FIG. 1 shows the general design of this electret power generator. As shown in FIG. 1, the Boland et al electret power generator is a capacitor-like structure with the electret 101 disposed between a stator electrode 103 and a rotor electrode 105 providing power to a load 109 and having an air gap 107 or other medium separating the rotor electrode 105 from the electret 101 and the stator electrode 103. Boland et al disclosed that the electret 101 comprised Teflon AF® charged with a back-lighted thyratron.

Other electret power generators have typically used the same general design as disclosed by Boland et al, but use different electret materials. Tsutsumino et al used CYTOP® as the electret material and achieved 38 μW at 20 Hz as described in “Seismic power generator using high-performance polymer electret”, Proc. Int. Conf. MEMS'06, 2006. Sterken et al demonstrated silicon oxide/silicon nitride electret micro power generators and generated 5 μW at 500 Hz with external biased voltages of 100 V as disclosed in “Harvesting energy from vibrations by a micromachined electret generator”, Proc. Int. Conf. Transducers 2007, 2007. Among these explored materials, CYTOP® is reported to have highest surface charge density, 1.37 mC/m².

Electret power generators generally require careful gap control between the rotor and the stator, otherwise performance of the generator is reduced. Power output of the generator depends upon capacitance between the electrodes of the generator located on the stator and rotor. Further, performance of electret generators is also impacted by the charge density of electret material used. Teflon AF® with a charge density of 0.5 mC/m² and CYTOP with a charge density of 1.37 mC/m² are of particular interest in electret power generators due to their ease of processing. Silicon oxide/silicon nitride materials have a charge density of 11.51 mC/m², but may be considered of lesser interest due to high-temperature processes that may render them inferior to polymer counterparts in certain applications.

Hence, there is a need in the art for a power generator that provides for micro power generation with increased power, but which can be manufactured and operated without requiring precise gap control.

### SUMMARY

An embodiment of the present invention is a power generator that has at least one a power generator structure, where the at least one power generator structure comprises: a first electrode mounted on a stator plate; a second electrode mounted on a stator plate, wherein the first electrode and second electrode are configured to be electrically coupled to a load; at least one rotor, wherein the at least one rotor is configured to slide substantially laterally between a first area over at least a portion of the first electrode and a second area over at least a portion of the second electrode; and electret material, wherein the electret material is between at least a portion of the first electrode and the at least one rotor when the at least one rotor is positioned over at least a portion of the first electrode and wherein the electret material is between at least a portion of the second electrode and the at least one rotor when the at least one rotor is positioned over at least a portion of the second electrode.

Another embodiment of the present invention is a method for power generation comprising: charging electret material disposed between one or more rotors and at least a portion of a first electrode and a second electrode; and sliding the one or more rotors substantially laterally between an area at least substantially above the first electrode and an area at least substantially above the second electrode.

Still another embodiment of the present invention is power generator comprising: a first means for conducting electrical charge disposed substantially planarly in a first plane; a second means for conducting electrical charge disposed substantially planarly in the first plane, wherein the first means for conducting electrical charge and the second means for conducting electrical charge are configured to be electrically coupled to a load; means for collecting electrical charge disposed in a second plane, wherein the second plane is above the first plane, and the means for collecting electrical charge is disposed to move substantially laterally in an area at least substantially above the first means for conducting electrical charge and an area at least substantially above the second means for conducting electrical charge; electret material, wherein the electret material is between at least a portion of the first means for conducting electrical charge and the means for collecting electrical charge and the electret material is between at least a portion of the second means for conducting electrical charge and the means for collecting electrical charge.

### BRIEF DESCRIPTION OF THE SEVERAL VIEWS OF THE DRAWINGS

FIG. 1 (prior art) shows an electret power generator.

FIG. 2A depicts an electret power generator having both electrodes on the stator and a metal rotor.

FIG. 2B depicts an electret power generator having both electrodes on the stator and an insulator rotor.

FIGS. 3A-3C illustrate power generation from an electret power generator having both electrodes on the stator and an insulator rotor.

FIG. 4 shows the chemical composition of parylene variants.

FIG. 5 shows the space distribution of a charged sample of parylene HT deposited on a soda lime wafer.

FIG. 6 shows the decaying of the surface potential of parylene HT® samples annealed at different temperatures.

FIG. 7A shows the thermally stimulated discharge (TSD) current and surface potential of a non-annealed parylene HT® sample.

FIG. 7B shows the TSD current and surface potential of a parylene HT® sample annealed at 400° C. for one hour before charging.

FIG. 8 shows a schematic view of a metal rotor power generator having two electrodes on the stator.

FIG. 9 shows a photograph of stator electrodes on a diced wafer after a metal deposition and dicing process.

FIG. 10 is a photograph showing the positioning of metal rotors within openings in an acrylic cover.

FIG. 11 shows a photograph of an assembled power generator.

FIG. 12 shows a photograph of a pair of parylene HT®-coated polyetheretherketone (PEEK) rotors.

FIG. 13 shows the surface potential of 8 pieces of PEEK rotor blocks after charging.

FIG. 14 shows a photograph of an assembled power generator using insulator rotors.

FIG. 15 shows an assembled power generator mounted on an electrodynamic shaker.

FIG. 16 shows the power output of a power generator using metal rotors.

FIG. 17 shows the power output of a power generator using insulator rotors.

FIG. 18 shows the power output as a function of load resistance for a power generator using metal rotors.

FIG. 19 shows the power output as a function of load resistance for a power generator using insulator rotors.

FIG. 20 shows time traces of output voltage for a power generator with metal rotors.

FIG. 21A and FIG. 21B show time traces of voltage outputs at 10 Hz and 50 Hz with optimal loads for a power generator using insulator rotors.

### DETAILED DESCRIPTION

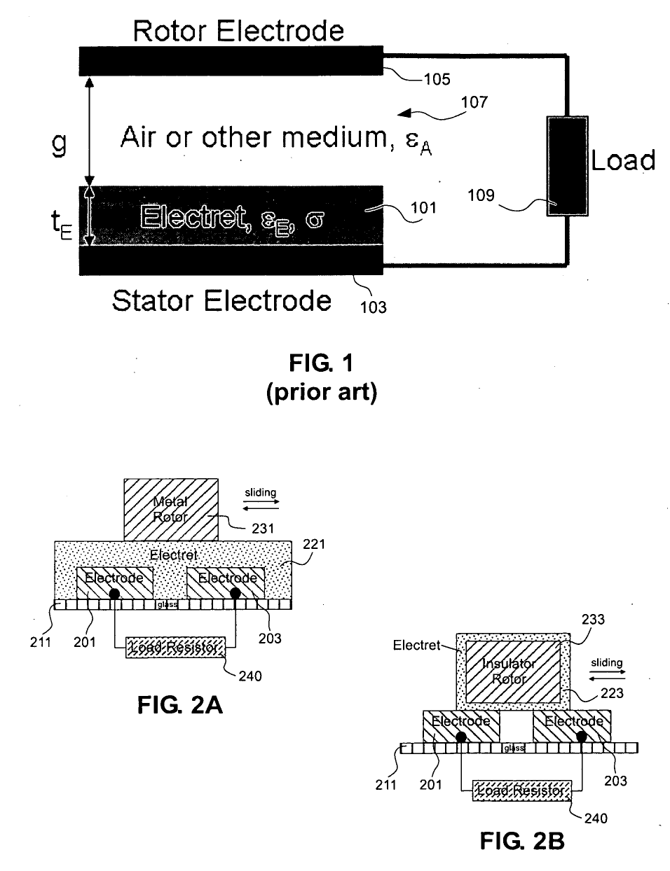

Boland and Tsutsumino showed that the maximum power output of an electret power generator is proportional to the surface charge density squared. The maximum power output for an electret power generator as depicted in FIG. 1 can be calculated as shown in Equation 1 below:

$${P}_{MAX} = \frac{{σ}^{2}}{\frac{4 {ɛ}_{0} {ɛ}_{E}}{{t}_{E}} ( \frac{{ɛ}_{E} g}{{ɛ}_{A} {t}_{E}} + 1 )} \cdot \frac{d A ( t )}{d t} \qquad ( Eq . 1 )$$

Where σ is the surface charge density, go is the vacuum permittivity, ε_{E} is the dielectric constant of electret, ε_{A} is the dielectric constant of air (i.e., ˜1), g is the gap distance from the top electrode to the electret surface, t_{E} is the electret thickness, and A (t) is the variable overlap area between the top and bottom electrodes.

From Equation 1, the power output of an micro electret power generator depends on several factors, such as the gap distance, g, the thickness of electret material, t_{E}, etc. Typical values ofε_{E}, the dielectric constant of polymer electrets are around 2. Therefore, when the gap distance is larger than two times of the electret thickness, the gap distance plays a dominant role for the output power. To maximize the output power, it is desirable to have as small a gap distance relative to the thickness of the electret as possible. The largest state-of-the-art thickness of electrets is 20 μm of CYTOP®, achieved by several consecutive spin-coatings. With this constraint, the gap distance has to be controlled within around 50 μm. Prior art approaches have allowed the gap distance to be controlled to 100 μm with precise x-y-z stages, to 500 nm with aspin-coated polymer gasket, and 1000 μm with PDMS-formed chambers. The need for gap-controlling structures often complicates the generator design and fabrication.

Some embodiments of the present invention utilize a design that has both electrodes on the stator and a rotor above the stator, as depicted in FIGS. 2A and 2B. The rotor stays in contact with the stator due to the gravity of the mass of the rotor and the coulomb attraction force between the rotor and the stator. This design differs from the conventional variable in-plane gap design shown in FIG. 1 and allows for the avoidance of the gap-controlling structures needed by generators relying on the design shown in FIG. 1. FIG. 2A shows a power generator having two electrode structures 201, 203 acting as a stator deposited on a stator plate glass layer 211. Electret material 220 is deposited on and around the electrode structures 201, 203. A metal rotor 231 is positioned above the electrodes 201, 203 and the electret material 221 so as to allow it to move laterally relative to the electrodes 201, 203. When the metal rotor 231 moves relative to the stator electrodes 201, 203, induced charges on the electrodes 201, 203 vary with the position of the rotor 231 and cause current flow through the load resistor 240.

FIG. 2B shows a similar structure to that depicted in FIG. 2A. As shown in FIG. 2B, the power generator comprises the two electrode structures 201, 203 positioned on the glass layer 211. Rather than depositing electret material on the electrodes 201, 203, the power generator depicted in FIG. 2B uses electret material 223 to coat a rotor 233. The rotor 233 is preferable made from insulating material, as discussed below. The electret-coated rotor 233 is positioned above the electrodes 201, 203 to allow it to move laterally relative to the electrodes 201, 203. When the electret-coated rotor 233 is made out of insulating material, the structure depicted in FIG. 2B configuration may have a larger power output since the induced charge density on the output electrodes 201, 203 may be higher than that obtained from the structure depicted in FIG. 2A.

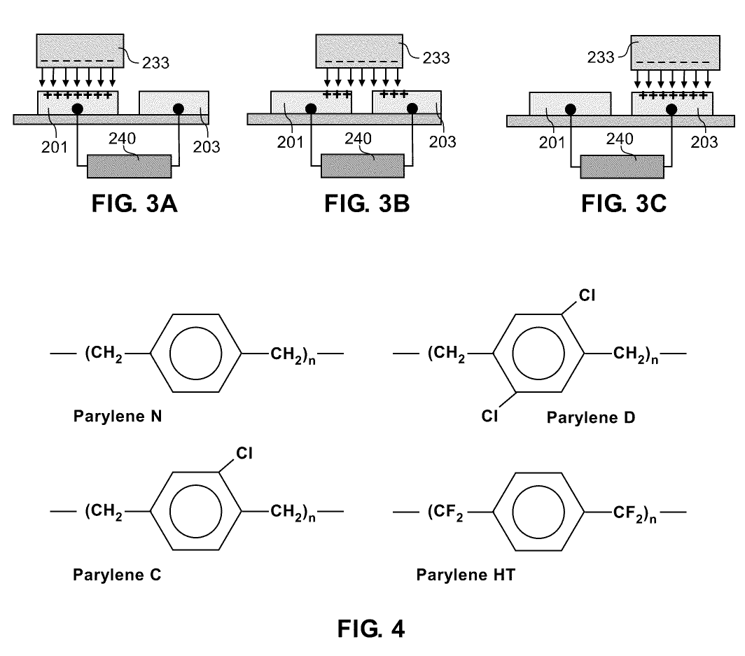

FIGS. 3A to 3C illustrate power generation from the power generator depicted in FIG. 2B. In FIG. 3A, the insulator rotor 233 is positioned above the first stator electrode 201 and the charge distribution is illustrated by the minus symbols on the rotor 233 and the plus symbols on the first electrode 201. As the rotor 233 moves towards the second electrode 203 as illustrated in FIG. 3B, the image charges on the first electrode 201 decrease and the charges on the second electrode 203 increase and a net current flows from the first electrode 201 through the load 240 to the right electrode 203. In FIG. 3C, the rotor 233 is fully positioned over the second electrode 203 and current flow through the load 240 stops since the charges are distributed between the rotor 233 and the second electrode 203. Movement of the rotor 233 back towards the first electrode 201 will again result in current flow through the load 240.

In the power generators depicted in FIGS. 2A and 2B, power is transduced into the load via charge induction and no gap control is required. Since no electrode is needed on the rotor, the rotor can be simply a moving object, made of metal or dielectric. The power generator designs depicted in FIGS. 2A and 2B do not need a tethering spring attached to the rotor, so these designs have no mechanical resonance (i.e., resonant frequency near zero). Hence, these generators can work at very low frequency as long as the relative motional force can break the frictional force induced by the attractive electrostatic force between the electret charges and their image charges on the electrodes.

As briefly discussed above, an electret is an insulating material that exhibits a net electrical charge or dipole moment. Parylene, or poly(p-xylylene), is a useful transparent polymer and is known to have electret properties. It has been used in a wide range of applications, particularly as a protective coating for biomedical devices and microelectronics. Parylene has other desirable properties including chemical inertness, conformal coating, and excellent barrier properties. Commonly available parylene variants include parylene C, N and D. Parylene HT® from Specialty Coating Systems (Indianapolis, Ind., USA) is another parylene variant. FIG. 4 shows the chemical composition of these parylene variants, although other parylene variants are known in the art. Parylene HT , like other parylenes, may be obtained by chemical vapor deposition at room temperature and can be patterned with an oxygen plasma using photoresist masks. Preferred embodiments of the present invention may use parylene HT® as electret material.

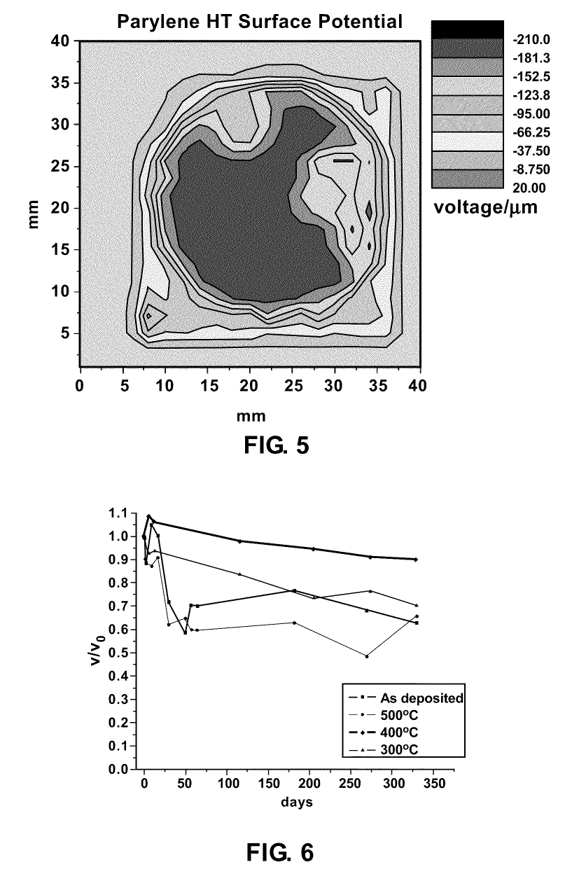

An important property for the use of electret material in power generators is the charge retention property of the electret material. To study the charge retention property of parylene HT®, it was first deposited on soda lime wafers. Next, the samples coated with parylene HT® were implanted with electrons with a corona discharge method using a base current of 0.02 μA, a grid current of 0.2 μA, a substrate temperature of 100° C., and a charging time of 60 minutes. The distribution of surface potential of the charged parylene HT was measured with an integrated system of Monroe Isoprobe® and computer-controlled x-y stage. Constant grid and base currents were employed, instead of constant needle and grid voltages as may be used in other corona discharge methods. The corona charger was controlled such that the currents of the base and the grid were maintained at the values described above by dynamically controlling the voltages of the needle and grid with PID controlling algorithms. FIG. 5 shows the space distribution of the charged sample. The highest surface potential observed was 204.58 V/μm, equivalent to a surface charge density of 3.69 mC/m². The surface potential of the electret depends on the thickness of the electret. Under the same corona charging conditions, thicker electret can achieve higher surface potential. Note that the surface charge density of 3.69 mC/m² is about 8 times the charge density of Teflon AF® and 2.7 times that of CYTOP.

Stability and long-term reliability of electret material is also an important property for electret-based power generators. To study the stability and long-term reliability of charged parylene HT® films, parylene HT® samples were first annealed in nitrogen ambient at 500° C., 400° C. and 300° C. for 1 hour before charging and the changes of surface potential over time were monitored. Samples were stored at the room temperature and 60% relative humidity. FIG. 6 shows the decaying of surface potential of parylene HT® annealed at different temperatures. As shown in FIG. 6, the as-deposited parylene HT® sample and the sample annealed at 500° C. show large initial drops of surface potential but maintain relatively stable values, at about 65% to 70% of initial value. The surface charge density of the 400° C.-annealed sample dropped to 91% of its initial value after 330 days. Therefore, it may be concluded that to maintain as high power output as possible, 400° C. annealing may be a better choice since it could retain 91% of initial surface potential, although it shows continuous decreasing trend. In terms of stability and predictability, no annealing or a higher temperature annealing may be preferred. Although they had initial drops of surface potential, the as-deposited sample and the 500° C.-annealed sample show fairly stable surface potential after 75 days. It may be preferable to have devices generating a lower power but more stable in time than the opposite.

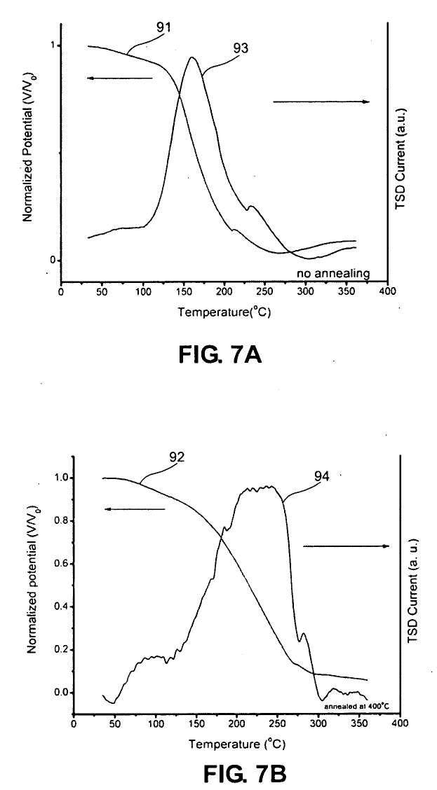

Thermally stimulated discharge (TSD) measurements were performed on charged parylene HT® samples in order to understand their thermal stability and discharging mechanism. When an electret is heated, the dipoles and/or charges can be discharged at an accelerated rate depending on the temperature and the material. Therefore, during such a heat-stimulated discharge, an electret sandwiched between two electrodes can generate a discharging current that sometimes shows a number of peaks when recorded under a ramping temperature. The shape and peaks then reveal important information of the mechanisms by which the electret stores the charges. A modified TSD measurement was used to measure both the discharging current and the surface potential as a function of the ramping temperature. The measuring electrode was placed 1 mm above the sample and current was measured with a Keithley 485 autoranging picoammeter and surface potential was also monitored with a Monroe Isoprobe. Samples were heated up at a rate of 1° C./min. FIG. 7A shows the TSD current (curve 93) and surface potential (curve 91) of the non-annealed parylene HT® sample. FIG. 7B shows the TSD current (curve 94) and surface potential (curve 92) of the parylene HT® sample annealed at 400° C. for one hour before charging. In FIGS. 7A and 7B, the surface potential shown is the surface potential normalized against initial values. The peak TSD current occurred at around 160° C. for the parylene HT samples without annealing, and 230° C. for the samples annealed at 400° C. for one hour before charging. A higher TSD peak temperature typically means a better capability to withstand high temperature. Therefore, pre-charging annealing may improve high-temperature reliability of parylene HT .

Returning to the power generator embodiments depicted in FIGS. 2A and 2B, the fabrication of exemplary devices using parylene HT® as the electret will now be described. The fabrication processes described below can be accomplished with conventional machining processes. Note that the use of conventional machining processes may result in devices with larger than desired dimensions. Microfabrication techniques may also be used to fabricate power generation devices according to embodiments of the present invention.

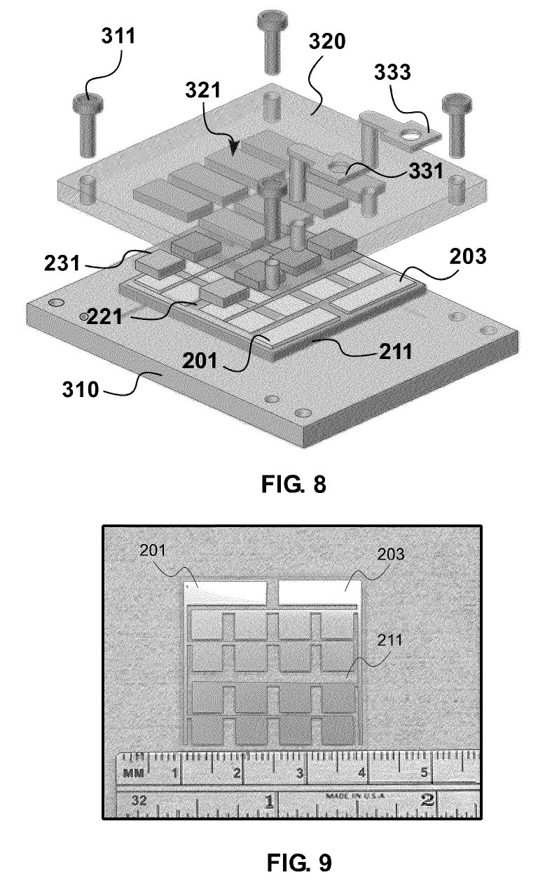

FIG. 8 shows a schematic view of the metal rotor power generator embodiment depicted in FIG. 2A. FIG. 8 shows a container comprising a base 310 and a cover 320 that both may be manufactured from acrylic material. The cover 320 may have openings 321 to receive the metal rotors 231 as described in additional detail below. Fasteners 311 are used to fasten the cover 320 to the base 310. Fabrication of the electrodes 201, 203 may be accomplished by the thermal evaporation and patterning of 200 nm Au and 10 nm Cr onto a soda lime glass wafer 211 via conventional photolithographic processes. The electrodes 291, 293 are two matrices of interconnected cells with dimensions of 5 mm by 5 mm with 2 mm spacing for each cell. Power contacts 331, 333 electrically contact the electrodes 201, 203. The glass wafer was diced to provide 30 mm-by-30mm stators. FIG. 9 shows a photograph of the stator electrodes 201, 203 on the diced wafer 211 after the metal deposition and dicing process. After dicing, 7.32 μm parylene HT® was deposited on the stator electrodes 201, 203 to provide the electret layer 221. Similar to parylene C and other parylene variants, parylene HT® can be deposited via a room temperature CVD process. After deposition, corona charging was done to implant electrons on the parylene HT® electret layer 221. The charging conditions may be as described previously( i.e., a base current of 0.02 μA, a grid current of 0.2 μA, a substrate temperature of 100° C., and a charging time of 60 minutes).

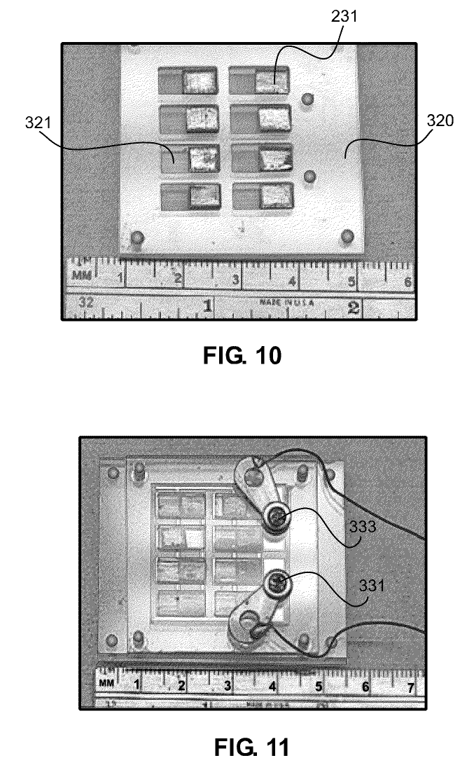

FIG. 10 is a photograph showing the positioning of the metal rotors 231 within the openings 321 of the cover 320. The metal rotors 231 are machined brass blocks having dimensions of 4.5 mm by 4.5 mm by 2 mm (L by W by H). As briefly discussed above, both the cover 320 and the base 310 may be fabricated from acrylic material. The openings 321 in the cover 320 are preferably sized and spaced to allow the metal rotors 321 to slide back and forth over the cells for each electrode 201, 203. The openings 321 may be cut into the acrylic material or otherwise formed in the acrylic material. Additional openings may be formed in the base 310 or cover 320 to receive the diced wafer 211. Other embodiments may use other material to form the base 310 and/or cover 320. FIG. 11 shows a photograph of an assembled power generator.

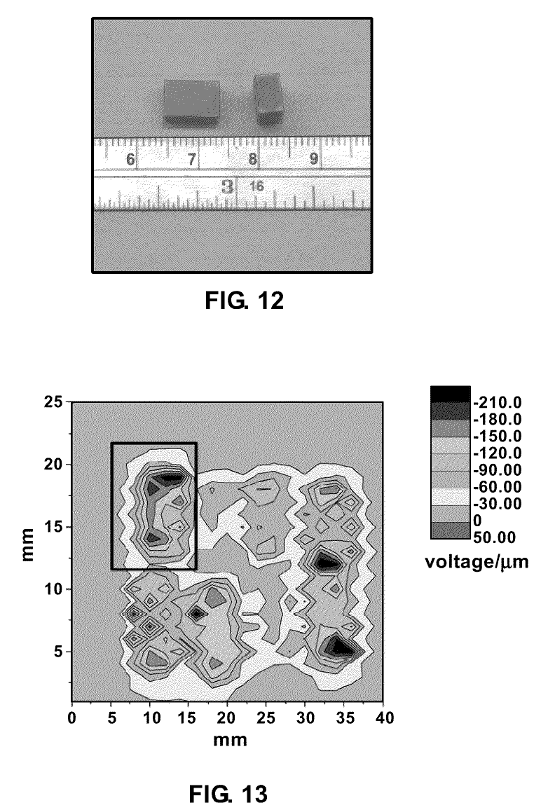

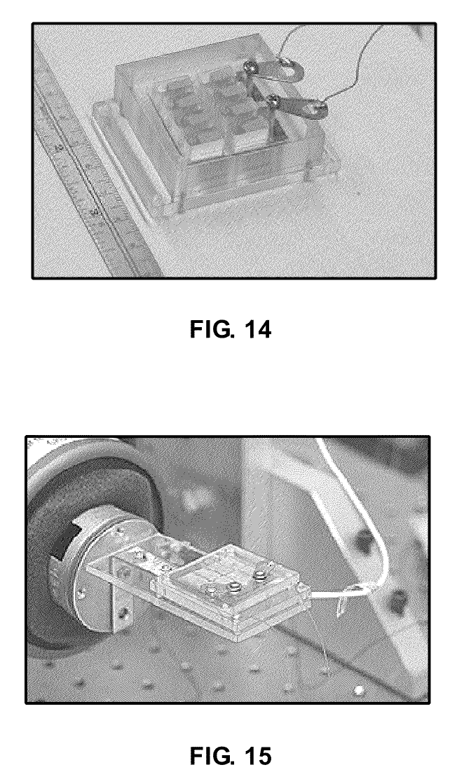

An insulated rotor power generator embodiment as depicted in FIG. 2B may be constructed similar to the power generator depicted in FIG. 8. That is, the power generator may have an acrylic base 310 and cover 320 with openings 321 to receive insulator rotors 233. Fabrication of the electrodes 201, 203 may be accomplished by the thermal evaporation and patterning of 150 nm Au and 10 nm Cr onto a soda lime glass wafer 211 via conventional photolithographic processes to form two separate matrices of interconnected 5 mm by 5 mm square pads. FIG. 9 shows the electrodes 201, 203 deposited on a diced glass wafer. However, instead of depositing parylene HT® on the stator electrodes 201, 203, the parylene HT® is deposited on the insulator rotors 233. The insulator rotors 233 may be fabricated by machining polyetheretherketone (PEEK) material. The dimensions of the rotor blocks are 5 mm by 6 mm by 9 mm (L by W by H). A 7.32 μm layer of Parylene HT® was deposited onto the PEEK rotors 233, and then charged via corona charging. Charging conditions are the same as described above. FIG. 12 shows a photograph of a pair of parylene HT®-coated PEEK rotors. FIG. 13 shows the surface potential of 8 pieces of PEEK rotor blocks 233 after charging. A single PEEK block is identified by the black rectangle frame in FIG. 12. FIG. 14 shows a photograph of an assembled power generator using insulator rotors.

To test the power output available from the power generators , the assembled generators were mounted onto a machined acrylic stage fixed to an electrodynamic shaker, as shown in FIG. 15. All necessary wires were soldered. Power generation experiments were performed using a Labworks Inc. ET-132-2 electrodynamic shaker, which was driven sinusoidally by a HP33120A function generator through a power amplifier. The acceleration of the power generator was measured with an Endevco256HX-10 accelerometer. The micro electret power generators were connected to resistive loads. In order to measure large output voltages, a simple two-resistor voltage divider was used as the load. The output voltage was measured through a National Semiconductor LF356N op-amp, a 10¹²-ohm input impedance voltage buffer. The maximal shaking amplitude, 5 mm, was defined by the external packaging container. The frequency varied from 10 Hz to 70 Hz and the load resistance from 50 to 2,000 Mohm.

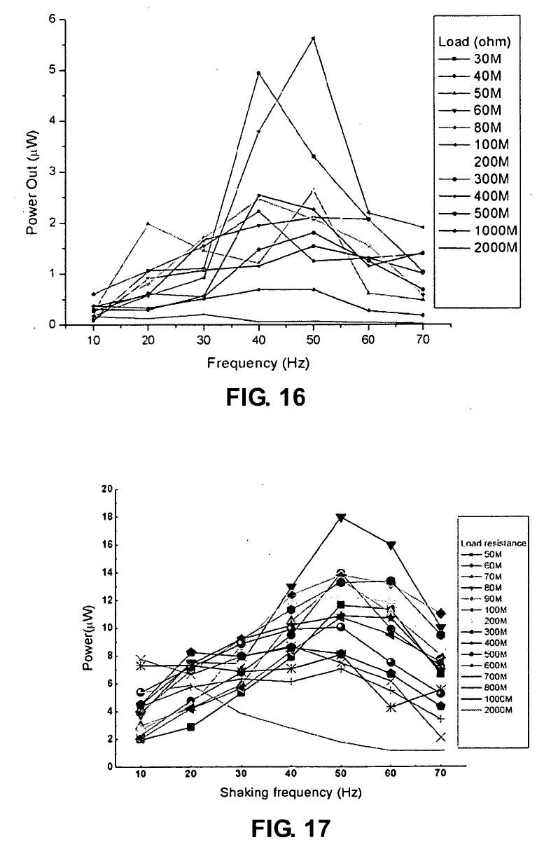

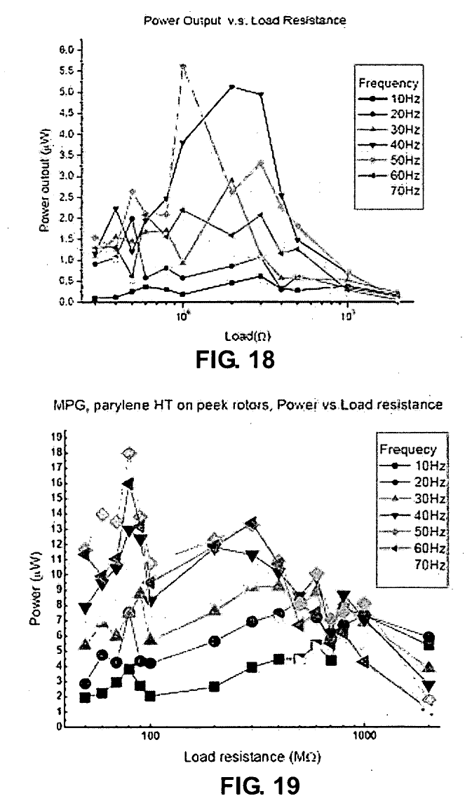

FIGS. 16 and 17 show power outputs of both devices as a function of frequency. FIG. 16 shows the power output of the power generator using metal rotors. FIG. 17 shows the power output of the power generator using insulator rotors. The maximum power output, 17.98 μW was obtained at 50 Hz with an external load of 80 Mohm for the generator with parylene HT®-coated PEEK rotors. FIG. 18 shows the power output as a function of load resistance for the power generator using metal rotors, while FIG. 19 shows the power output as a function of load resistance for the power generator using insulator rotors. As the devices are aimed to harvest power from natural vibrations, the low-frequency performance is of special interest. The generator with parylene HT®-coated PEEK rotors can harvest 7.7 μW at 10 Hz and 8.23 μW at 20 Hz. As expected, the generator with PEEK rotors produced larger power than the one with metal rotors. The ratio is close to 4. This can be explained by the fact that the induced charge density on the electrodes of the generator with PEEK rotors is twice that of the generator with metal rotors. According to Equation 1, power output is proportional to the square of charge density.

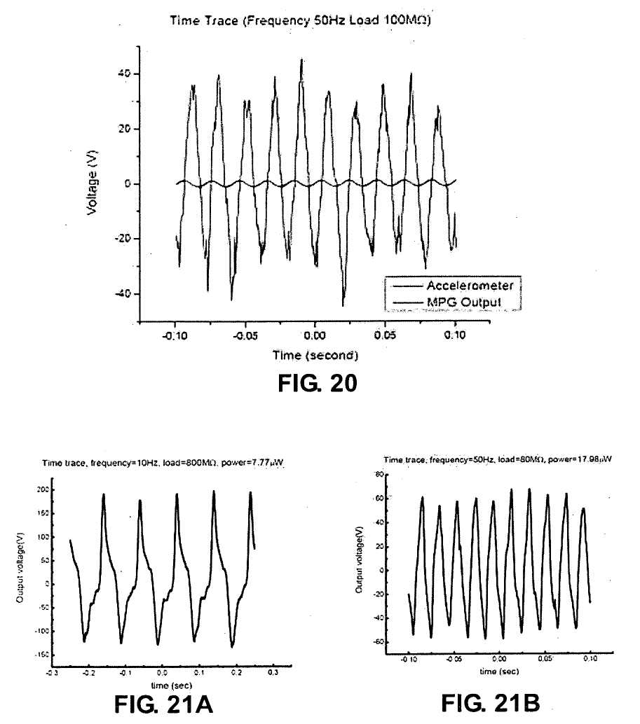

Due to the capacitive nature of the electret power generators described above, there is an optimal load for optimal power generation. For the power generator using metal rotors, the optimal load was experimentally found to be 100-200 MΩ. Using the optimal 100 MΩ load, a maximum power output of 5.6 μW at 50 Hz with a sinusoidal-like waveform is produced. Time traces of output voltage are shown in FIG. 20. FIGS. 21A and 21B show time traces of voltage outputs at 10 Hz and 50 Hz with optimal loads for the power generator using insulator rotors.

Power generators according to the embodiments depicted in FIGS. 2A and 2B can fully deliver power as designed when the rotor moves completely from one electrode to the other, which, in the embodiments immediately described above, is equivalent to the shaking amplitude of 5 mm. However, due to the limitation of the shaker used for the described testing, it was impossible to produce enough energy for the rotor to have 5 mm amplitudes at frequencies higher than 50 Hz. According to the specifications of the ET-132-2 electrodynamic shaker, the maximum peak sine output force is 7 pounds, equivalent to 31.136 Newton. The maximum acceleration the shaker could exert on the power generator assembly is around 576.6 m/s², since the power generator assembly has 54-gram mass. The maximum displacement of the shaker is 5.84 mm at 50 Hz, 4.05 mm at 60 Hz and 2.98 mm at 70 Hz (displacement is calculated by assuming the shaking motion is ideal simple harmonic). At higher frequencies, the rotor only moves in partially its supposed amplitude and hence the generator produces less power. The shaker's failure to provide enough shaking amplitude at frequencies higher than 50 Hz is at least a factor in the overall output power decrease in the frequency range higher than 50 Hz as shown in FIGS. 16 and 17. This phenomenon results from the large dimensions of the rotors. It can be improved with smaller rotors, smaller confining chambers and thus smaller shaking amplitudes.

One way to assess the capability of a micro power generator is to calculate power density. For the devices described immediately above, the total volume including the external container is 50 cm³. Taking that into consideration, the power density of these devices is around 0.36 μW per cm³ at 50 Hz. This seemingly low power density is due, in part, to the unnecessary volume resulting from the external package and the rotor blocks. To improve the power densities, one can carefully design an external packaging container that requires the least amount of volume. Further, the PEEK rotors of the device using insulator rotors have a dimension of 5 mm by 6 mm by 9 mm so that it has enough mass to overcome the electrostatic attraction forces between the rotor and stator electrodes during vibration. Choosing other insulating materials that have higher densities may further reduce the volume of the electret rotors and thus the total volume of the fabricated generator and provide for increased power density.

Large optimal load resistance is a limitation of electret-based power generators known in the art, preventing wide applications of such devices. It is the nature of electret power generators to produce outputs with large voltage but small current. One approach for overcoming this limitation according to embodiments of the present invention would be connecting in parallel as many generator cells as possible to provide large enough current. The embodiments described above have only 8 cells in the device. However, other embodiments may use more cells to provide a higher power output. According to embodiments of the present invention, shrinking the dimension of cells with microfabrication processes can increase the number of cells per devices and reduce the shaking amplitude, generate higher current under the same condition, and thus lower the required load resistance while producing large enough power.

Alternative embodiments of the present invention are not limited to the use of acrylic for the external packaging. Other materials such as PEEK, polyurethane, metal, and other suitable materials may be used for the external packaging. Further, the shape and dimension of the external packaging are not limited to the embodiments described above. The shapes and dimensions may be varied for specific applications or to provide for improvements in performance.

Embodiments of the present invention are not limited to the rotors described above. The shapes of the rotors are not limited to the generally rectangular shapes described above. Materials for the metal rotors are not limited to brass. Such rotors may be made from other metals, other conducting or semi-conducting materials, or other materials capable of providing for charge transfer. With respect to insulator rotors, the material of the rotors is not limited to PEEK. Other materials such as polyurethane, metal, semiconducting materials, etc. may be used.

Preferred embodiments of the present invention use parylene variants such as parylene HT® as the electret material. However, the thickness of the parylene HT® is not limited to the thicknesses described above. As indicated, annealing of the parylene HT® may be preferred, but the annealing temperature is not limited to 400° C. Higher or lower temperatures may be used. Further, the use of oxygen-free ambients, such as nitrogen, argon, helium, etc., are preferred for the annealing of the electret. Additionally, the charge implantation method for the electret is not limited to corona charging. Other charge implantation methods, such as (but not limited to) back lighted thyratron electron beam implantation may be used.

Alternative embodiments of the present invention may comprise stator structures different than those described above. For example, the material of the stator plate is not limited to soda lime glass. Other materials such as polyurethane, PEEK, and other applicable materials may be used. The material of the stator electrodes is not limited to Gold/Chromium. Other metals such as aluminum, copper, etc., may be used. Further, the shapes and dimensions of the electrodes may also differ from the shapes and dimensions described above.

The foregoing Detailed Description of exemplary and preferred embodiments is presented for purposes of illustration and disclosure in accordance with the requirements of the law. It is not intended to be exhaustive nor to limit the invention to the precise form or forms described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising step(s) for . . . ”

What is claimed is:

1. A power generator comprising a power generator structure, wherein the power generator structure comprises:
a first electrode mounted on a stator plate;
a second electrode mounted on a stator plate, wherein the first electrode and second electrode are configured to be electrically coupled to a load;
at least one rotor, wherein the at least one rotor is configured to slide substantially laterally between a first area over at least a portion of the first electrode and a second area over at least a portion of the second electrode; and
electret material, wherein the electret material is between at least a portion of the first electrode and the at least one rotor when the at least one rotor is positioned over at least a portion of the first electrode and wherein the electret material is between at least a portion of the second electrode and the at least one rotor when the at least one rotor is positioned over at least a portion of the second electrode.

2. The power generator according to claim 1, wherein the electret material comprises parylene.

3. The power generator according to claim 2, wherein the electret material has been annealed.

4. The power generator according to claim 3, wherein the electret material has been annealed at a temperature of around 400° C. for a period of about 1 hour.

5. The power generator according to claim 1, wherein the electret material has been deposited on and around at least a portion of the first electrode and has been deposited on and around at least a portion of the second electrode.

6. The power generator according to claim 1, wherein the electret material has been deposited on at least a portion of the at least one rotor.

7. The power generator according to claim 5, wherein the at least one rotor comprises conducting or semi-conducting material.

8. The power generator according to claim 6, wherein the at least one rotor comprises at least one of the following materials: conducting material; semi-conducting material, or insulating material.

9. The power generator according to claim 1 further comprising two or more power generator structures wherein the first electrode and second electrode of each power generator is connected in parallel or in series with the first electrode and second electrode of at least one other power generator.

10. A method for power generation comprising:
charging electret material disposed between one or more rotors and at least a portion of a first electrode and a second electrode; and
sliding the one or more rotors substantially laterally between an area at least substantially above the first electrode and an area at least substantially above the second electrode.

11. The method according to claim 10, wherein the electret material comprises parylene.

12. The method according to claim 10, wherein the electret material has been deposited on and around at least a portion of the first electrode and has been deposited on and around at least a portion of the second electrode.

13. The method according to claim 10, wherein the electret material has been deposited on at least a portion of at least one of the one or more rotors.

14. The method according to claim 10, wherein the one or more rotors comprise conducting or semi-conducting material.

15. The method according to claim 10, wherein the one or more rotors comprise at least one of the following materials: conducting material; semi-conducting material, or insulating material.

16. A power generator comprising:
a first means for conducting electrical charge disposed substantially planarly in a first plane;
a second means for conducting electrical charge disposed substantially planarly in the first plane, wherein the first means for conducting electrical charge and the second means for conducting electrical charge are configured to be electrically coupled to a load;
means for collecting electrical charge disposed in a second plane, wherein the second plane is above the first plane, and the means for collecting electrical charge is disposed to move substantially laterally in an area at least substantially above the first means for conducting electrical charge and an area at least substantially above the second means for conducting electrical charge; and
electret material, wherein the electret material is between at least a portion of the first means for conducting electrical charge and the means for collecting electrical charge and the electret material is between at least a portion of the second means for conducting electrical charge and the means for collecting electrical charge.

17. The power generator according to claim 16, wherein the electret material comprises parylene.

18. The power generator according to claim 17, wherein the electret material has been annealed.

19. The power generator according to claim 18, wherein the electret material has been annealed at a temperature of around 400° C. for a period of around 1 hour.

20. The power generator according to claim 16, wherein the first means for conducting electrical charge comprises a plurality of interconnected first electrodes disposed on an insulating surface and the second means for conducting electrical charge comprises a plurality of interconnected second electrodes disposed on the insulating surface.
